(19) United States
(12) Patent Application Publication
(10) Pub. No.: US 2026/0156237 A1
(43) Pub. Date: Jun. 4, 2026

(54) LARGE-ANGLE MULTI-USER AUTOSTEREOSCOPIC DISPLAY SYSTEMS AND METHODS FOR USING THE SAME

(71) Applicant: GOOGLE LLC, Mountain View, CA (US)

(72) Inventors: John D. Perreault, Mountain View, CA (US); Brian R. Rankin, San Carlos, CA (US); Xuejian Li, Fremont, CA (US); Bennett S. Wilburn, Saratoga, CA (US)

(21) Appl. No.: 19/406,567

(22) Filed: Dec. 2, 2025

Related U.S. Application Data
(60) Provisional application No. 63/727,040, filed on Dec. 2, 2024.

(51) Int. Cl. H04N 13/312; H04N 13/305; H04N 13/368; H04N 13/383

(52) U.S. Cl. CPC H04N 13/312; H04N 13/305; H04N 13/368; H04N 13/383

(57) ABSTRACT

According to an aspect, large-angle multi-user autostereoscopic display systems are disclosed that include steerable backlight units that include parallax barriers and diffusers configured to direct backlight through a selectively-transmissive display pixel matrix and lenticular array to form stereoscopic images at a desired viewer location.

### CROSS-REFERENCE TO RELATED APPLICATION

This application claims priority to U.S. Provisional Patent Applicaiton No. 63/727,040, filed on Dec. 2, 2024, entitled “LARGE-ANGLE MULTI-USER AUTOSTEREOSCOPIC DISPLAY SYSTEMS AND METHODS FOR USING THE SAME”, the disclosure of which is incorporated by reference herein in its entirety.

### BACKGROUND

Autostereoscopic displays provide a viewer with a perception of three-dimensional (3D) depth by displaying separate stereoscopic images for the viewer's left eye and right eye without requiring the use of separate headgear, such as glasses.

### SUMMARY

At a high level, this disclosure describes a technology for 3D displays that allows multiple people to see a glasses-free 3D image at the same time, from different positions. The main problem with current glasses-free 3D screens is that they have a very small sweet spot where the 3D effect works, making it impossible for a group to watch together. At least one solution is a smart backlight system that can steer the light from the display. Using built-in cameras, the system tracks where each viewer's eyes are located. It then projects a unique 3D image tailored for each person directly to their position. It does this for every person in the room by rapidly switching between them, so fast that everyone sees a clear, continuous 3D video stream simultaneously. For example, a family could watch a 3D movie together on the couch, with each person seeing a perfect 3D image from their own seat, even if they move around. In a video game, two players could sit side-by-side and each see their own private, full-screen view of the game on the same display, instead of using a split-screen. This technology overcomes the major limitations of current glasses-free 3D displays, enabling a shared, high-quality 3D experience.

In some aspects, the techniques described herein relate to a system, including: a backlight that includes an array of backlight pixels, a diffuser, and a parallax barrier located between the array of backlight pixels and the diffuser; a lenticular array; and a selectively-transmissive display pixel matrix located between the backlight and the lenticular array; wherein the backlight is configured to activate a subset of the backlight pixels to form a stereoscopic pair of images directed towards a detected viewer pose.

In some aspects, the techniques described herein relate to a system, wherein the system directs stereoscopic pairs of images across a viewing cone greater than 70 degrees and within an illumination cone less than 40 degrees.

In some aspects, the techniques described herein relate to a system, wherein the parallax barrier includes elongate apertures oriented in a vertical direction.

In some aspects, the techniques described herein relate to a system, wherein the array of backlight pixels include columns of pixels that are transverse to the elongate apertures.

In some aspects, the techniques described herein relate to a system, wherein the parallax barrier is disposed directly adjacent the array of backlight pixels.

In some aspects, the techniques described herein relate to a system, wherein the diffuser is disposed directly adjacent the parallax barrier.

In some aspects, the techniques described herein relate to a system, wherein the parallax barrier provides a directionality to light emitted by the backlight pixels for directing the stereoscopic pair of images towards the detected viewer pose.

In some aspects, the techniques described herein relate to a system, wherein the diffuser diffuses elongate brightness non-uniformities emitted by the parallax barrier to provide a more uniform illumination of the selectively-transmissive display pixel matrix.

In some aspects, the techniques described herein relate to a system, wherein the diffuser is a top hat diffuser.

In some aspects, the techniques described herein relate to a system, further including a display controller configured to: activate a first subset of the backlight pixels for display of a first frame such that light emitted from the first subset of backlight pixels is steered through the parallax barrier and forms first display light in a first direction; and activate a second subset of the backlight pixels for display of a second frame such that light emitted from the second subset of backlight pixels is steered through the parallax barrier and forms second display light in a second direction that is different than the first direction.

In some aspects, the techniques described herein relate to a system, further including: a viewer tracking subsystem configured to track a pose of a corresponding one or more viewers; wherein the first subset of backlight pixels is selected based on a pose of a first viewer such that the first direction intersects with the pose of the first viewer; and wherein the second subset of backlight pixels is selected based on a pose of a second viewer such that the second direction intersects with the pose of the second viewer.

In some aspects, the techniques described herein relate to a system, wherein: each of the first frame and the second frame includes a three-dimensional composite frame including a first subset of pixels representing image content for a left eye of a viewer of one or more viewers and a second subset of pixels representing image content for a right eye of the viewer.

In some aspects, the techniques described herein relate to a method including: activating a first subset of backlight pixels of a backlight of a display panel to transmit light through a parallax barrier adjacent the backlight, a diffuser disposed adjacent the parallax barrier, a selectively-transmissive display pixel matrix disposed adjacent the diffuser, and a lenticular array disposed adjacent the selectively-transmissive display pixel matrix so that the display panel emits first display light representative of a first frame in a first direction relative to the display panel; and activating a second subset of backlight pixels of the backlight to transmit light through the parallax barrier, the diffuser, the selectively-transmissive display pixel matrix, and the lenticular array so that the display panel emits second display light representative of a second frame in a second direction different than the first direction relative to the display panel.

In some aspects, the techniques described herein relate to a method, wherein the first display light forms a first stereoscopic pair of images within a first illumination cone that is less than 40 degrees, the second display light forms a second stereoscopic pair of images within a second illumination cone that is less than 40 degrees, and an angular distance between the first illumination cone and the second illumination cone is greater than 70 degrees.

In some aspects, the techniques described herein relate to a method, further including: determining a first pose of a first viewer and a second pose of a second viewer; selecting the first subset of backlight pixels based on the first pose of the first viewer; and selecting the second subset of backlight pixels based on the second pose of the second viewer.

In some aspects, the techniques described herein relate to a method, further including: generating the first frame based on the first pose of the first viewer; and generating the second frame based on the second pose of the second viewer.

In some aspects, the techniques described herein relate to a method, wherein the first frame and the second frame each include a three-dimensional (3D) composite frame including a first subset of pixels representing image content for a left eye of at least one of the first viewer or the second viewer and a second subset of pixels representing image content for a right eye of the at least one of the first viewer or the second viewer.

In some aspects, the techniques described herein relate to a method, wherein: activating the first subset of backlight pixels produces a first bar pattern of backlighting; and activating the second subset of backlight pixels produces a second bar pattern of backlighting.

### BRIEF DESCRIPTION OF THE DRAWINGS

FIG. 1 illustrates a top-down view of an autostereoscopic display system according to some implementations;

FIG. 2 illustrates an exploded cross sectional side view and functional block diagram of a display system according to some implementations;

FIG. 3 illustrates a cross-sectional view of a portion of a display panel according to some implementations;

FIG. 4 illustrates design parameters that influence a size of a illumination cone generated by a stereoscopic display panel according to some implementations;

FIG. 5A illustrates a cross-sectional view of a portion of a backlight unit and parallax barrier according to some implementations;

FIG. 5B illustrates the results of an optical simulation of a backlight unit according to some implementations;

FIG. 6A illustrates the results of an optical simulation of light transmission through a parallax barrier according to some implementations;

FIG. 6B illustrates the results of an optical simulation of light transmission through a parallax barrier and a diffuser according to some implementations;

FIG. 7A illustrates the results of an optical simulation of the performance of a top hat diffuser over a range of incident light angles according to some implementations;

FIG. 7B illustrates the results shown in FIG. 7A over a smaller Y axis scale relevant for estimating crosstalk due to the tophat diffuser;

FIG. 8 is a flow diagram illustrating a method for providing 3D image display to multiple viewers using an autostereoscopic display system having a steerable backlight according to some implementations;

FIG. 9 is a diagram showing a plan view of an example operation of an autostereoscopic display system in accordance with the method of FIG. 8;

FIG. 10 is a diagram showing a plan view of an example operation of an autostereoscopic display system in accordance with the method of FIG. 8;

FIG. 11 is a diagram illustrating a perspective view of the example operation of FIG. 9 according to some implementations; and

FIG. 12 is a diagram illustrating a perspective view of the example operation of FIG. 10 according to some implementations.

### DETAILED DESCRIPTION

The systems and methods described herein address a fundamental limitation of conventional glasses-free 3D displays: the inability to support multiple viewers in different locations. The core problem is that such displays typically project a 3D image into a single viewing area. The technical solution presented is a display with a steerable backlight. This system uses eye-tracking to locate multiple viewers and then directs a custom-rendered 3D image to each viewer's specific position by selectively activating different parts of the backlight. For instance, in a collaborative work environment, several engineers could view a 3D model of a product on the same screen, with each person seeing the model from their own perspective, as if it were a physical object on a table.

Conventional lenticular autostereoscopic displays have a technical problem in which they exhibit tradeoffs between the number of viewer positions supported and the pixel resolution of three-dimensional (3D) imagery displayed. Implementations of the present disclosure include technical solutions that have the technical effect of maintaining a high pixel resolution while supporting multiple viewers in multiple possible positions and with a separate video presentation for each viewer. In some implementations the technical solutions include steerable backlight units in combination with a selectively-transmissive display pixel matrix and a lenticular array overlying the display pixel matrix. Through selective activation of a subset of backlight pixels of the backlight unit in combination with a parallax barrier and diffuser, the backlighting emitted by the subset of backlight pixels can be transmitted, or steered, at an intended angle or direction relative to the selectively-transmissive display pixel matrix. Accordingly, the display light resulting by the transmission of the directional backlight emission through the selectively-transmissive display pixel matrix is likewise transmitted through the lenticular array overlying the selectively-transmissive display pixel matrix at a corresponding angle relative to the surface, or plane, of the transmissive panel matrix. As such, a two-dimensional (2D) frame or composite 3D frame, for example, a frame formed from the interleaving of pixels from a left-eye image and pixels of a right-eye image of a stereoscopic image pair, can be steered or directed toward an expected viewer position through activation of the subset of backlight pixels associated with that expected viewer position. In this manner, multiple viewers can be supported by successively steering different frames for different viewers to their respective expected viewer positions. Further, in some examples, the autostereoscopic display system employs head/eye pose tracking so as to track the poses of one or multiple viewers, and thus estimate or determine the expected viewer position, and, more specifically, the viewer's eye positions in some implementations, thereby facilitating accurate steering of the displayed image for that viewer.

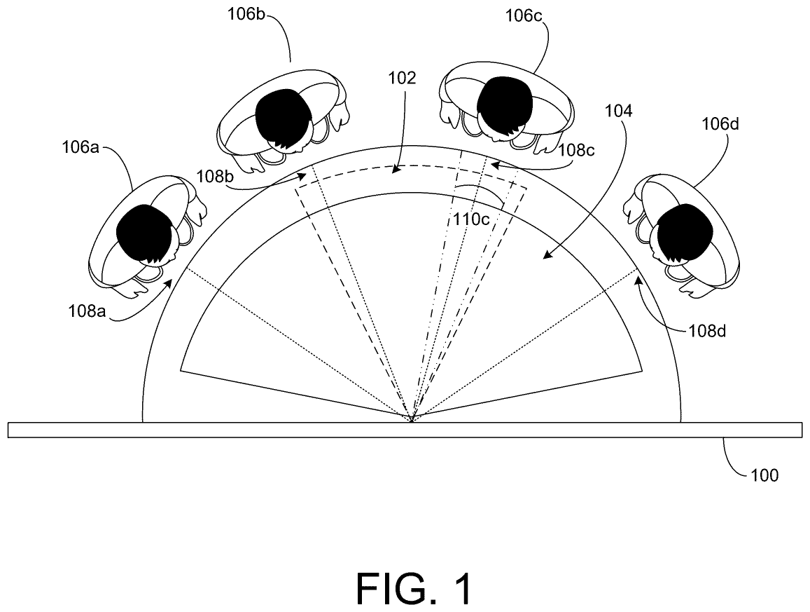

FIG. 1 is a top-down view of an autostereoscopic display system 100 made in accordance with the present disclosure that employs a steerable backlight unit to support multiple concurrent viewers 106a, 106b, 106c, 106d. FIG. 1 conceptually illustrates a conventional viewing cone 102 associated with conventional autostereoscopic displays and also shows an improved widened viewing cone 104 provided by autostereoscopic display system 100. As shown, in a conventional lenticular display, only a relatively narrow viewing cone 102 is possible, such as a range of viewing angles that is less than approximately 50 degrees. Such a narrow range of viewing angles limits the physical space in which users 106a-106d can be positioned in front of the display thereby preventing concurrent use by multiple users. A narrow viewing cone 102 also limits the ability of a user 106a-106d to move relative to the display system 100. By contrast, improved widened viewing cone 104 supports a wide range of viewing angles, which provides a greater area over which users 106a-106d can be positioned, thereby allowing for multiple users 106a-106d, such as the four users shown in FIG. 1, to use the display at the same time.

In some examples, display system 100 is configured to provide time multiplexed stereoscopic images directed to viewpoints 108a, 108b, 108c, 108d associated with the location of corresponding users 106a-106d, with each image displayed across a corresponding illumination cone 110 a-110d (only 110c illustrated and labeled). As described below, display system 100 is configured to direct images to a viewpoint, e.g., viewpoint 108a-108d within viewing cone 104 while maintaining a sufficiently narrow illumination cone 110a-110d for a given image set so that images intended for a given user 106a-106d are only seen by that user and not in the field of view of adjacent users. The sufficiently narrow illumination cone 110a-110d prevents adjacent users from perceiving undesirable crosstalk from adjacent user images.

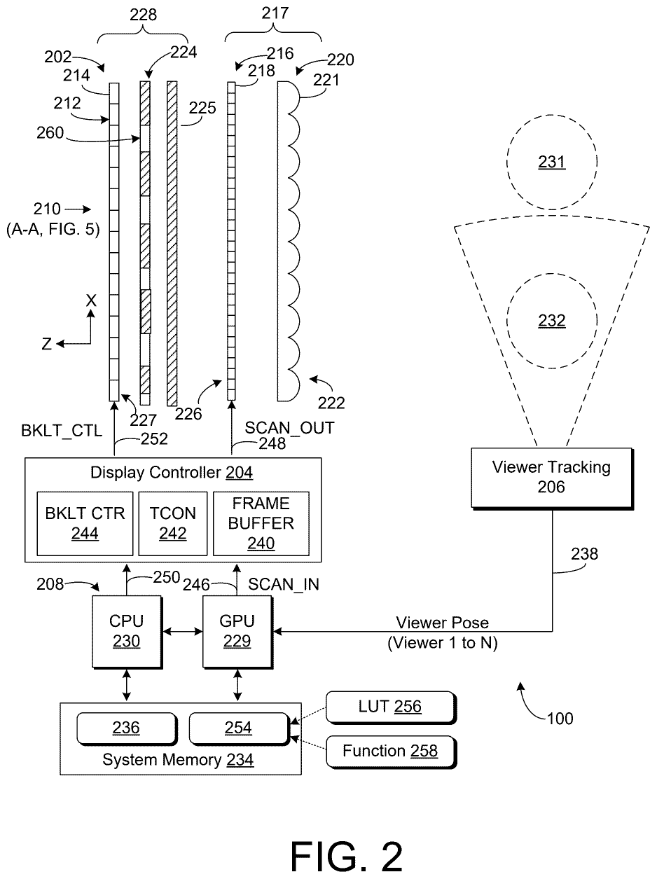

FIG. 2 is an exploded cross sectional side view and functional block diagram of display system 100. The display system 100 comprises any of a variety of electronic systems utilized to display video or other imagery, including computer monitors, video gaming devices, televisions, tablet computers, laptop computers, and other panel displays. The display system 100 includes a display panel 202, a display controller 204, a viewer tracking subsystem 206, and a video subsystem 208. Although illustrated as separate from the display panel 202 for ease of reference, in some embodiments one or more of the display controller 204, viewer tracking subsystem 206, and video subsystem 208 may be integrated as part of the display panel 202.

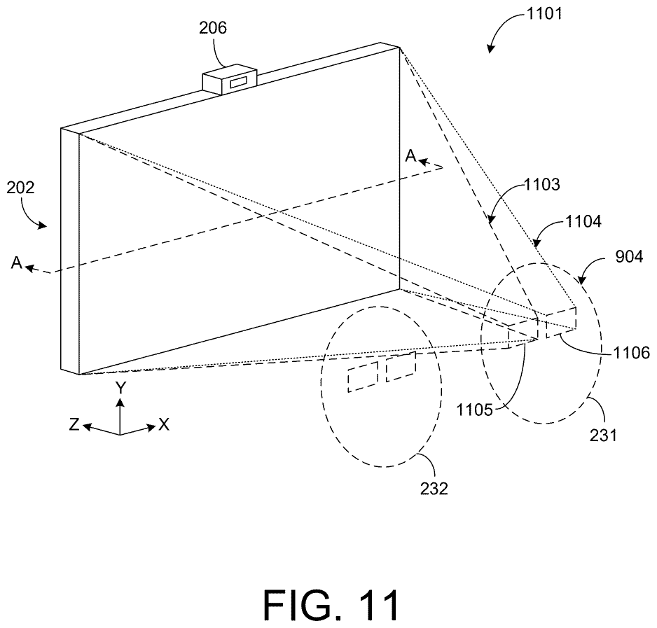

As shown by cross-section view 210 (corresponding to cut A-A along the X-Z plane shown in FIG. 11), the display panel 202 is a transmissive-type display panel that includes a backlight 212 composed of a matrix or other two-dimensional array of backlight pixels 214 (e.g., white-light LEDs) and a selectively-transmissive display pixel matrix 216 (which can be referred to as a display pixel matrix that is selectively-transmissive) similarly composed of a matrix or other two-dimensional array of transmissive display pixels 218 (e.g., composed of red, green, and blue (RGB) sub pixel LEDs). Selectively-transmissive display pixel matrix 216 and lenticular array 220 form a 3D image modulation unit 217 that modulates stereoscopic image information to generate a 3D image. The transmissive display pixels 218 can include any of a variety of display pixels configured to selectively filter or block incident backlight from the backlight 212 based on a corresponding pixel value in order to configure the resulting transmitted light to affect a particular color and intensity. Examples of such transmissive display pixels include active-matrix or passive-matrix liquid crystals (LCs), such as thin-film-transistor (TFT) LCs. In some examples, the display pixel matrix 216 has a higher resolution (that is, greater number of pixels) than the backlight 212, in other examples the resolution of the backlight 212 may meet or exceed the resolution of the display pixel matrix 216. The lenticular array 220 is overlying or otherwise disposed adjacent to a viewer facing side 222 of the display pixel matrix 216. The lenticular array 220, in one embodiment, is composed of an array or other matrix of magnifying lenses 221, known as lenticules, that when viewed from different angles magnify different regions of an underlying base. Accordingly, as described in greater detail below, the overlay of the lenticular array 220 and the display pixel matrix 216, when used in conjunction with display of a composite 3D frame composed of an interleaved (e.g., by column) stereoscopic pair of images, presents a full-parallax stereoscopic display content to a viewer.

Further, to facilitate provision of 3D image content in specified directions relative to the face of the display panel 202 (which in turn facilitates supporting multiple concurrent viewers), in at least one embodiment the display panel 202 further includes a steerable backlight unit 228, which includes backlight 212, a parallax barrier 224, and a diffuser 225. Parallax barrier 224 and diffuser 225 are disposed between, and substantially parallel to, a back-facing side 226 of the display pixel matrix 216 and a front-facing side 227 of the backlight 212. In an example, parallax barrier 224 includes an opaque layer in which transparent apertures 260 are formed. The apertures 260 are parallel and evenly spaced and, in some examples, extend vertically with respect to an intended orientation of the display. In some examples any of a variety of other parallax barrier designs may be used, including dynamic or moving parallax barriers, such as an electrically controlled parallax barrier.

A backlight pixel can be an individually controllable light-emitting element within a two-dimensional array that collectively forms a backlight for a display, wherein each backlight pixel can be selectively activated to contribute to a spatially and directionally controlled illumination pattern. In some implementations, a backlight pixel can refer to a discrete source of illumination, such as a light-emitting diode (LED), arranged in a grid, which provides light that is subsequently modulated by a parallax barrier and a selectively-transmissive display pixel matrix to form a viewable image. In some implementations, a backlight pixel can be a single, addressable unit within a backlight system configured to emit light upon activation, wherein a pattern of activated backlight pixels is used to steer illumination in a particular direction.

In some implementations, a parallax barrier can refer to an optical component comprising an opaque layer having a pattern of transparent apertures configured to selectively block portions of light from a light source to impart directionality to the transmitted light. In some implementations, a parallax barrier can be an optical element that provides a collimating function by physically obstructing light rays except for those traveling in a specific angular range, thereby creating a directional illumination pattern. In some implementations, a parallax barrier can be a component positioned between a backlight and a display matrix, which includes a series of openings designed to control the angle at which light passes, enabling the steering of illumination to one or more specific viewing zones.

In some implementations, a diffuser can be an optical component configured to scatter transmitted light to increase its angular spread and homogenize its spatial intensity. In some implementations, a diffuser can refer to an optical element, such as a sheet of translucent material or a surface with engineered micro-structures, that is positioned in a light path to spread light from a non-uniform source to produce a more uniform illumination field. In some implementations, a diffuser can be a component in a backlight system that is placed after a collimating element, such as a parallax barrier, to expand the angle of the collimated light and smooth out intensity variations caused by the collimating element's structure.

The physical arrangement of the backlight 212, parallax barrier 224, diffuser 225, selectively-transmissive display pixel matrix 216, and lenticular array 220 as shown in cross-section view 210 has the effect that backlight emitted by a particular backlight pixel 214 is directed by the parallax barrier 224 and diffuser 225 through the selectively-transmissive display pixel matrix 216 and then through the lenticular array 220 in a particular direction. As such, display light resulting from the modification of emitted backlight as it traverses the selectively-transmissive display pixel matrix 216 is emitted by the display panel 202 in a particular direction (relative to the display surface of the display panel 202) that is based on the particular location of the backlight pixel 214 that emitted the backlight. Accordingly, as described in greater detail herein, the backlight 212 is configured to permit different subsets of backlight pixels 214 to be activated separately, and through the activation of a particular subset of backlight pixels 214, the resulting display light emitted by the display panel 202 can be controlled to be emitted in a corresponding direction. In this manner, the backlight 212, parallax barrier 224 and diffuser 225 collectively operate as the steerable backlight unit 228 that is operable to steer display light representative of the visual content of a frame being displayed in a particular direction. As such, the display panel 202 can be controlled to steer different successive displayed images to different viewer locations, and thus allow 3D content to be viewed by multiple viewers concurrently without requiring the viewers to wear special headgear.

To this end, the display system 100 utilizes the viewer tracking subsystem 206 to track the pose of each of one or more viewers, such as the two viewers 231, 232 illustrated in FIG. 2. The viewer tracking subsystem 206 includes any of a variety of systems employed for head and/or eye pose tracking known in the art. For example, the viewer tracking subsystem 206 can include a stereoscopic camera subsystem that utilizes reflected infrared (IR) light or other structured light to detect the presence of a viewer's face and further to detect the position and orientation, also referred to as the pose, of a viewer's eyes relative to the display panel 202. For ease of reference, the systems and techniques of the present disclosure generally are described in the context of eye pose tracking, but these descriptions apply equally to head tracking more generally, and thus reference to a viewer's pose refers to any of a relative position of one or both eyes of a viewer, an orientation of one or both eyes of a viewer, a relative position of a head of a viewer, an orientation of the head of a viewer, or combinations thereof, unless otherwise noted. Further, for purposes of the following, the viewer's pose is described herein with reference to the display surface of the display panel 202 (that is, an X-Y plane defined by the display panel 202) at a point at, for example, the center of the display panel 202. However, in other embodiments, the pose may be defined relative to a different fixed reference, such as a center point between two cameras of the tracking subsystem 206, a specified corner of the display panel 202, and the like.

The video subsystem 208, in one embodiment, includes one or more processors, such as at least one central processing unit (CPU) 230 and at least one graphics processing unit (GPU) 229, at least one system memory 234, and various input/output (I/O) devices, mass storage devices, and the like (not illustrated). The system memory 234 stores one or more software programs executed by one or both of the CPU 230 and GPU 229, such as a video generation software application 236 that includes executable instructions that manipulate the CPU 230 and GPU 229 to generate sequences of image frames also referred to herein as frames, for one or more viewers. The video generation software application 236 can include, for example, a rendering-based application that renders frames composed primarily of computer graphics, such as a video game application, a decoding-based application that generates frames by decoding previously-encoded frames (such as a television streaming application), or a combination thereof (such as an augmented reality application that renders an AR overlay for a decoded real-world video stream).

In at least one embodiment, the generated frames are 3D composite frames composed of a left-eye image interlaced with a right-eye image, the left-eye image and right-eye image together forming a stereoscopic image pair that when viewed by the respective left eye and right eye of a viewer provides the viewer with stereoscopic perception of depth such that images have the appearance of solidity and relief as though seen in three dimensions, also referred to herein as a 3D image. Further, in some embodiments, the video subsystem 208 generates separate streams for each viewer tracked by the viewer tracking subsystem 206. Thus, for the two viewers 231, 232 in the example of FIG. 2, the video subsystem 208 generates one stream of composite frames for viewer 231 and another stream of composite frames for viewer 232. As described in greater detail below, the GPU 229 utilizes current viewer pose information 238 for a given viewer as determined and provided by the viewer tracking subsystem 206 to generate the corresponding video stream to reflect that viewer's current pose in the visual content represented in the frames of the video stream. For example, the visual content represented in the frames can be rendered so as to correspond to the perspective of the viewer relative to the display panel 202 as based on the viewer's current pose.

In the illustrated embodiment, the display controller 204 includes a frame buffer 240, a timing controller (TCON) 242, and a backlight controller 244. The display controller 204 may be implemented as, for example, a display driver integrated circuit (DDIC) that can be part of the display panel 202 itself, as part of the video subsystem 208, or a component disposed between the two. The frame buffer 240 may be implemented as, for example, graphics random access memory (GRAM) or, in some embodiments, part of the system memory 234, and operates to temporarily buffer the pixel data of frames generated by the video subsystem 208 and transferred from the GPU 229 via a SCAN_IN signal 246. The timing controller 242 is coupled to the frame buffer 240 and includes clock sources and programmable or fixed logic operable to transfer the pixel data stored for a frame in the frame buffer 240 to the display pixel matrix 216 typically on a line-by-line basis using a SCAN_OUT signal 248 as well as various other timing and control signals (not illustrated) using any of a variety of techniques or protocols known in the art.

The backlight controller 244 (denoted BLK_CTR in FIG. 2) is coupled to the timing controller 242 and has an input to receive backlight configuration information 250 from the CPU 230 or other component of the video subsystem 208, and based on the backlight configuration information 250 generate a backlight control (BKLT_CTL) signal 252 that selectively activates a corresponding subset of backlight pixels 214 of the backlight 212 to steer or direct resulting display light emitted by the display panel 202 in a corresponding direction. In at least one embodiment, the system memory 234 includes a viewer steering application 254 that includes executable code that manipulates the CPU 230 to identify, for a selected viewer, the viewer's current pose from the viewer pose information 238 provided by the viewer tracking subsystem 206, determine a direction of that viewer relative to the display panel 202 based on the viewer's current pose, and then provide a representation of the determined direction to the backlight controller 244 as the backlight configuration information 250. Then, as noted above, the backlight controller 244 activates a corresponding subset of backlight pixels 214 so that the emitted backlight is steered through the selectively-transmissive display pixel matrix 216 by the parallax barrier 224 and diffuser 225 in a direction that intercepts the viewer's current position, and thus presenting the visual content of the frame currently displayed at the selectively-transmissive display pixel matrix 216 in the emitted display light.

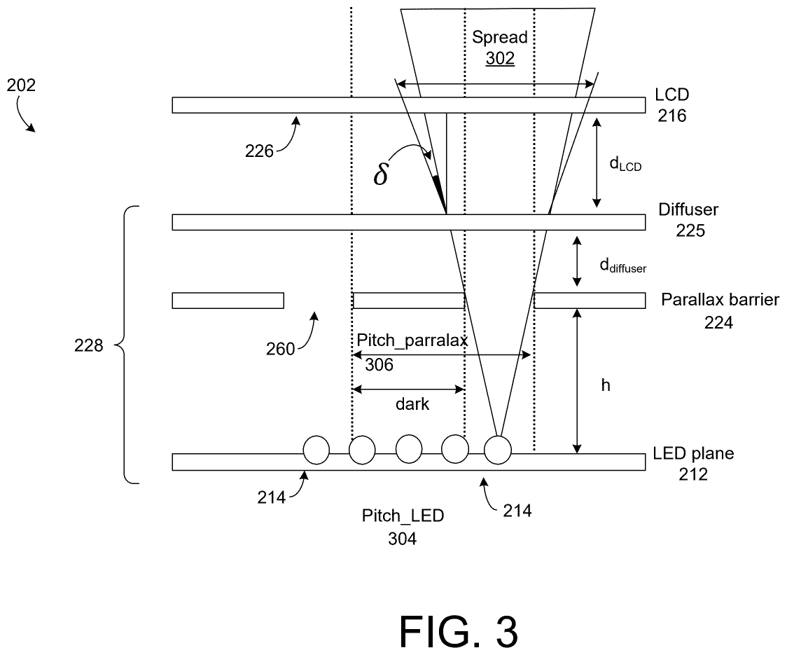

FIG. 3 conceptually illustrates a cross-sectional view of a portion of display panel 202 and design parameters that may be relevant for achieving wide viewing cones 104. Steerable backlight unit 228 is configured to illuminate back-facing side 226 of selectively-transmissive display pixel matrix 216 such that back-facing side 226 is substantially uniformly illuminated. The steerable backlight unit 228 is also designed and configured to provide a directionality to the backlight illumination such that the image generated by the display for a given image frame is transmitted in a desired direction over a sufficiently narrow angle for a given user viewpoint. For example, display panel 202 may be configured to provide stereoscopic images for a given viewpoint 108a-108d with a sufficiently narrow illumination cone 110 a-110d (FIG. 1) of, for example, approximately 40 degrees or less, and in some examples, approximately 30 degrees or less and in some examples, approximately 20 degrees or less, to avoid unwanted crosstalk between different users while also being capable of selectively steering the image to any viewpoint over the viewing cone 104, such as, for example, a viewing cone greater than 60 degrees, and in some examples, a viewing cone greater than 70 degrees, and in some examples, a viewing cone greater than 80 degrees, and in some examples, a viewing cone greater than 90 degrees, and in some examples, a viewing cone greater than 100 degrees. In an example, this combined performance of precise illumination cones 110a-110d steerable over a wide viewing cone 104 may be achieved by selecting, designing, and configuring the dimensional parameters of display panel 202 including those illustrated in FIG. 3.

The ability to steer an image over a wide viewing cone 104 is achieved in part by a parallax barrier 224 which provides a collimating function to the light emitted by backlight pixels 214 to provide a desired directionality to the emitted backlight. Each of backlight pixels 214 may include one or more light emitting elements, such as white LEDs. The pixels 214 may be disposed in a matrix of rows and columns, and in some examples, the columns may extend in a substantially vertical direction and be parallel to apertures 260 of parallax barrier 224. In other examples, rather than being parallel, the columns of backlight pixels 214 may extend at a non-parallel angle with respect to the apertures 260, with one or both of the columns of backlight pixels 214 or apertures 260 being non-parallel or transverse to a central vertical axis of the display panel 202. Providing columns of backlight pixels 214 that are non-parallel or transverse with respect to apertures 260 can allow for a lower pixel pitch 304 while maintaining the same steerability across viewing cone 104. A pitch 304, or spacing, of the backlight pixels 214 may be smaller than a pitch 306 of the parallax barrier which can be beneficial for achieving a higher steering resolution. In some examples a size of the illumination cone 110a-110d is a function of (1) the distance, h, between the backlight 212 and the parallax barrier 224; (2) the size of the parallax barrier apertures 260 and; (3) a width or size of the individual backlight pixels 214. For example, while keeping other parameters constant, a size of the backlight pixels 214 can be configured or selected to achieve a desired size of illumination cone 110a-110d, with the size of the illumination cone increasing with the size of the individual backlight pixels 214.

Light transmitted through apertures 260 of parallax barrier 224 is then diffused by diffuser 225 to extend over a wider angle,, to achieve a desired spread 302 of light to achieve a substantially uniform illumination of δ back-facing side 226 of selectively-transmissive display pixel matrix 216.

The spread 302 of the backlight illumination can be approximated by the following equation:

$$Spread ≅ 2 ( h + {d}_{diffuser} + {d}_{L C D} ) tan ( γ / 2 ) + 2 {d}_{L C D} tan δ \qquad Eqn . ( 1 )$$

wherein:
h is the distance between the LED plane of backlight 212 and the parallax barrier 224;
d_{diffuser} is the distance between the parallax barrier 224 and the diffuser 225
d_{LCD} is the distance between the diffuser 225 and the selectively-transmissive display pixel matrix 216
γ is the light emission angle through aperture 260; and
δ is half of the diffuser angle.

Thus, the foregoing parameters may be designed and selected to achieve the desired uniform illumination of back-facing side 226.

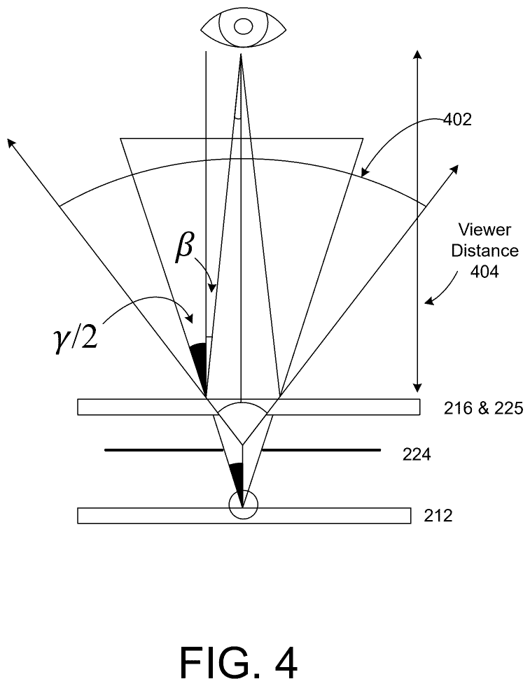

FIG. 4 illustrates design parameters that influence the size of an illumination cone 402 generated by display panel 202. In an example, the following Equations 2-4 may be used as an approximation to assess whether a set of design parameters for a desired viewing cone 104 will also provide a sufficiently narrow illumination cone 402.

$$tan ( β ) = pitch / ( 2 * viewer ) \qquad Eqn . ( 2 )$$

wherein:
β is the subtended half angle of the parallax barrier pitch 306 at viewer distance 404;
Pitch is the pitch 306 of parallax barrier 224; and viewer is the distance of the viewer from the display panel (viewer distance 404);

$$diffuser\_angle = γ / 2 + β \qquad Eqn . ( 3 )$$

wherein:
γ and β are defined above.

$$illumination cone = γ + 2 * diffuser\_angle \qquad Eqn . ( 4 )$$

wherein:
γ and diffuser_angle are defined above.

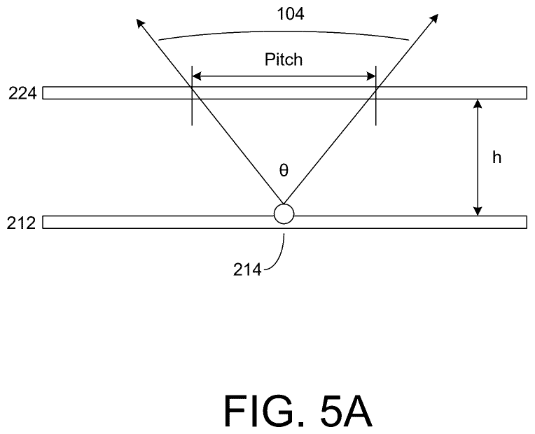

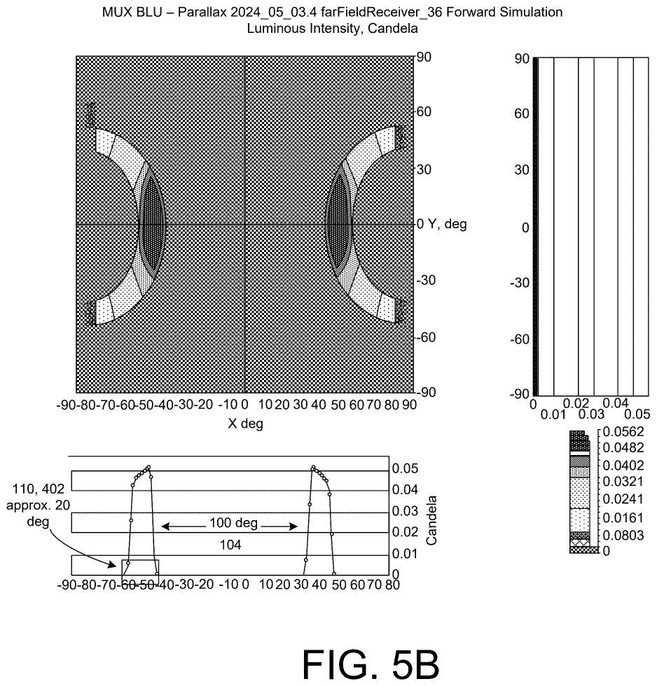

FIG. 5A shows a cross-sectional view of a portion of backlight 212, one backlight pixel 214, and parallax barrier 224. The viewing cone 104 for the illustrated arrangement can be described by the following equation:

$$tan ( θ / 2 ) = pitch / ( 2 h ) \qquad Eqn . ( 5 )$$

Wherein θ is the viewing cone 104 angle.

From the foregoing, a pitch and spacing, h, can be determined for a desired viewing cone 104, (θ).

FIG. 5B illustrates the results of an optical simulation using a ray tracing simulation tool for assessing the dual performance targets described above of a sufficiently wide viewing cone 104 while maintaining sufficiently narrow illumination cones 110a-110d, 402. The results illustrated in FIG. 5B show an example implementation of display panel 202 with steerable backlight unit 228 that provides an illumination cone 110a-110d, 402 of approximately 20 degrees over a viewing cone 104 of 100 degrees.

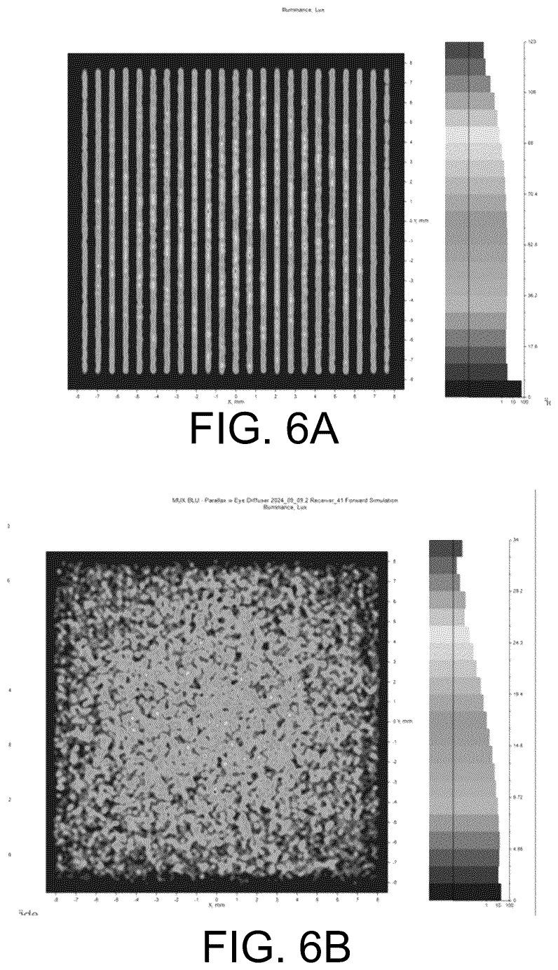

FIGS. 6A and 6B are images from an optical simulation that illustrate the function of diffuser 225. Both images represent what a user would see looking at the display. FIG. 6A illustrates backlight illumination in an example that includes parallax barrier 224 without the diffuser 225. As shown in FIG. 6A, the apertures of the parallax barrier create vertical elongate brightness nonuniformities. FIG. 6B, which repeats the simulation with both the parallax barrier 224 and the diffuser 225 illustrates the ability of the diffuser to substantially remove the brightness non-uniformities created by the parallax barrier 224 and provide a substantially uniform illumination of the selectively transmissive display pixel matrix 216. In the illustrated example, a ten degree top hat diffuser was used. In other examples, other diffuser types known in the art may be used. For example, display systems of the present disclosure may include diffusers, such as the diffuser 225, which may have an intensity profile that is flat-top (also referred to herein as a top hat diffuser), Gaussian, or super-Gaussian. Diffusers of the present disclosure can have a square, rectangular, circular, elliptical, or line intensity shape.

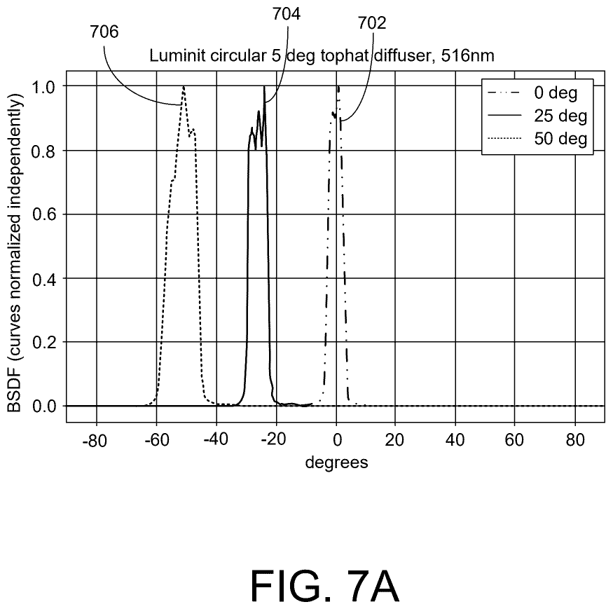

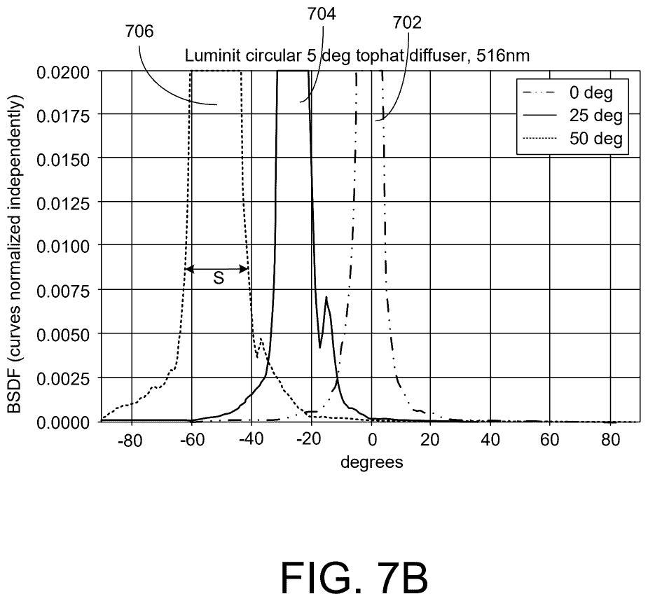

FIGS. 7A and 7B illustrate measured data of the performance of a top hat diffuser over a range of incident light angles with incident light angle along the X axis and bidirectional scattering distribution function (BSDF) along the Y axis. FIG. 7B shows the same data over a smaller Y axis scale, so that the amount of crosstalk caused by the diffuser can be estimated. FIGS. 7A and 7B show the diffuser performance for a 0 degree (curve 702), approximately 25 degree (704), and approximately 50 degree (curve 706) incident light angle. The data were collected using a 5 degree top hat diffuser. The spacing, S (labeled in FIG. 7B for the 50 degree incident angle case) in a given curve relates to a corresponding illumination cone 110a-110d that would result from the given incident light angle. FIG. 7B shows that the illumination cone 110a-110d increases as the incident light angle increases (the spacing, S, increases), however, at the relatively high off-center incident light angle of approximately 50 degrees (curve 706), the angular spread, S, is still approximately 20 degrees, indicating the diffuser will provide a sufficiently narrow illumination cone 110a-110d over a relatively wide viewing cone 104, such as a viewing cone greater than 100 degrees (2* the incident light angle of approx. 50 degrees).

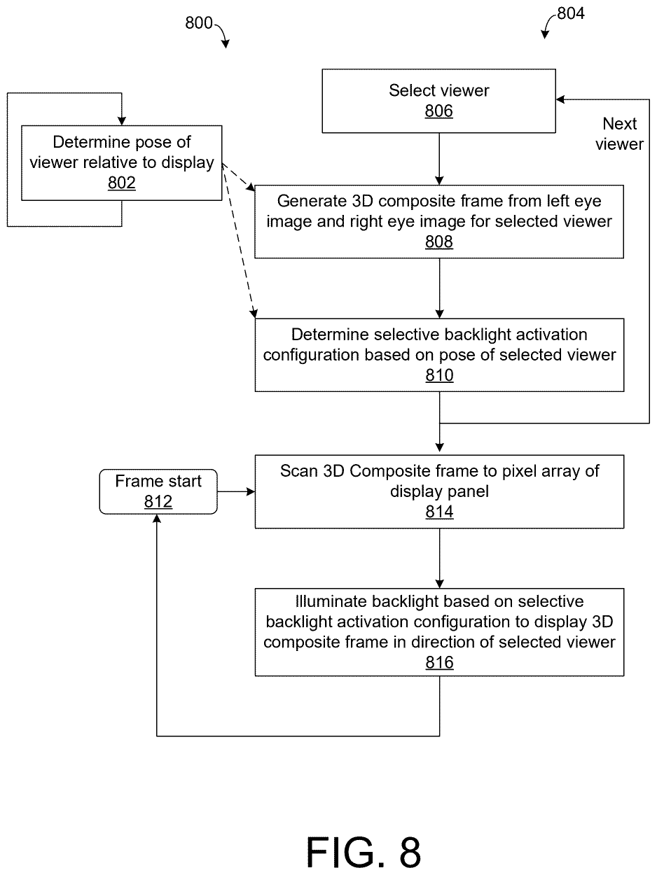

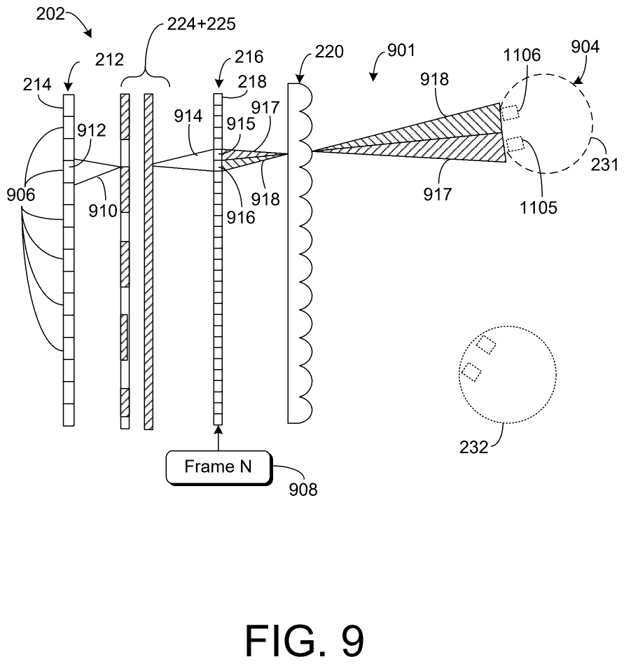

FIG. 8 depicts a method 800 that illustrates an example of a multi-viewer operation of the display system 100 of FIG. 2 in greater detail. For purposes of illustration, the method 800 is described below with reference to FIGS. 9-12 illustrating an example plan view of a two-viewer operation. However, while a particular example with two viewers is illustrated, it will be appreciated that the described technique can be extended to any number of viewers using the disclosure provided herein.

As illustrated, the method 800 includes two subprocesses: a viewer tracking subprocess 802 and a viewer display subprocess 804. In the viewer tracking subprocess 802, the viewer tracking subsystem 206 uses any of a variety of techniques to identify the presence of each viewer present within a certain range of the display surface of the display panel 202, and for each identified viewer, monitors a current viewer pose for that viewer. To illustrate, the viewer tracking subsystem 206 can use any of a variety of face detection algorithms to detect the presence of a viewer's face, and then utilize any of a variety of pose detection algorithms to detect the location and orientation of the detected face, or in some instances, the eyes of the detected face, and repeatedly update this information. Such techniques can utilize stereoscopic image capture and analysis, and in some examples, depth sensing using IR light or structured light projection, and the like. The current viewer pose for each detected viewer, such as viewers 231 and 232 of FIG. 2, is then periodically transmitted to the video subsystem 208 as viewer pose information 238, as described above.

In the method 800, the viewer display subprocess 804 represents the process of displaying a composite frame to a particular viewer through steering of the display light generated by the display panel 202 via the parallax barrier and diffuser-based steerable backlight 228 such that the display light is projected from the display panel 202 in a direction that intercepts the current pose of the corresponding viewer. Accordingly, as an initial step, at block 806 a viewer is selected from the one or more viewers identified at the current iteration of subprocess 802. This selection can include, for example, a round-robin selection, or may be based on some form of prioritization, such as selecting viewers closer to the display panel 202 at a higher ratio than viewers further from the display panel 202.

At block 808, execution of the video generation software application 236 at the video subsystem 208 manipulates the GPU 229 to generate a 3D composite frame and buffer the composite frame in the frame buffer 240. The composite frame, as noted above, is a combined stereoscopic pair of images that may contain both a left-eye image and a right-eye image that, when viewed by the respective eyes of the viewer, present a stereoscopic sense of depth for the displayed imagery. In some examples the combination of images is implemented in an alternating column approach, such that, for example, the even columns of the composite frame contain the columns of the left-eye image while the odd columns of the composite frame contain the columns of the right-eye image. As is known in the art, when such a composite frame is viewed through a lenticular array, such as the lenticular array 220, the particular view angles presented by the lenticules result in separation of the display light emitted from the even columns into display light transmitted to one exit pupil (e.g., the left eye exit pupil) and display light emitted from the odd columns into display light transmitted to another exit pupil (e.g., the right eye exit pupil). In at least one embodiment, the CPU 230 receives the current viewer pose information 238 for the selected viewer and directs the GPU 229 to render the composite frame so as to reflect the current viewer pose using any of a variety of well-known or proprietary 3D rendering techniques, such as those frequently employed to provide a sense of depth for virtual reality (VR) headsets or augmented reality (AR) headsets based on a pose of the user relative to a reference coordinate system for a virtual world or the real world.

At block 810, execution of the viewer steering application 254 manipulates the CPU 230 to identify a selective backlight activation configuration that, in conjunction with the parallax barrier 224 and diffuser 225, will cause emitted backlight to be steered through the display pixel matrix 216 in a direction that will intercept the viewer at the current viewer pose detected for that viewer. The viewer steering application 254 then provides a representation of the identified selective backlight activation configuration as backlight configuration information 250 for the upcoming frame period. This selective backlight activation configuration represents a corresponding subset of backlight pixels 214 that, when activated, emit backlight that is then collimated by parallax barrier 224 and transmitted at a corresponding angle relative to the plane of the selectively-transmissive display pixel matrix

216, and thus result in transmission of the resulting display light in the intended direction to intercept the viewer.

The particular subset of backlight pixels 214 that result in display light being transmitted in a corresponding direction is a function of the physical arrangement of the backlight pixels 214 in the backlight 212, the pitch, configuration, and arrangement of the parallax barrier 224, the distance between the backlight 212 and the parallax barrier 224, and the position and characteristics of diffuser 225, among others. The subset of backlight pixels 214 may be a subset of columns of the backlight pixels 214 that forms or produces a bar pattern of black, or dark, (inactivated) and white, or bright, (activated) stripes of columns, where the period, duty cycle, and phase of the bar pattern is configured based on the pose of the corresponding viewer. Other patterns and configurations of the subset can be implemented depending on the configuration of the display panel 202 and its corresponding lenticular and display pixel components.

The correspondence between subsets of backlight pixels 214 and corresponding display light projection directions can be determined in any of a variety of ways. In some embodiments, the components of the display panel 202 are modeled or simulated and the correspondences between subset and display direction determined through this modeling/simulation. In other embodiments, a test system having the same configuration is constructed, and then different subsets of backlight pixels 214 are activated and their corresponding steered display directions are detected using a photometer or other testing tool. The resulting determined correspondences then can be represented for subsequent reference and determination by the viewer steering application 254 using any of a variety of techniques. For example, in some embodiments, the correspondences between activation of different subsets of backlight pixels 214 and the resulting display light projection directions is represented in a look up table (LUT) 256 (FIG. 2), with, for example, each entry of the LUT 256 storing an identifier or other representation of a specific subset of backlight pixels 214 and being indexed based on a representation of a corresponding pose (e.g., an angle of the pose relative to the display surface of the display panel 202). Accordingly, the viewer steering application 254 can determine the appropriate representation of a received current viewer's pose, index an entry of the LUT 256 based on this representation, and determine a representation of the corresponding subset of backlight pixels 214 that need to be activated in order to steer the backlight, and thus steer the resulting display light, in a direction that intercepts the current viewer's pose. As another example, the correspondences between viewer poses/steered backlight direction and corresponding subset of backlight pixels 214 activated can be represented using a function representation 258 (FIG. 2).

At the start of the next frame period (represented by block 812), the display controller 204 may scan pixel data of a composite frame generated and buffered at block 808 out to the corresponding display pixels 218 of the selectively-transmissive display pixel matrix 216 via the SCAN_OUT signal 248 (and other timing and control signals, not illustrated) at block 814. At block 816, the backlight controller 244 uses the selective backlight activation configuration identified in the backlight configuration information 250 provided at block 810 to selectively activate the backlight pixels 214 included in the subset identified by the backlight configuration information 250 while maintaining the other backlight pixels 214 in a deactivated state (or in some embodiments, at a very low level of activation compared to the activation level of the pixels of the selected subset). The backlight pixels 214 of the subset, thus activated, emit backlight that is collimated by parallax barrier 224 and diffused by the diffuser 225 of the backlight unit in a particular direction relative to the selectively-transmissive display pixel matrix 216. Meanwhile, with the display pixels 218 of the display pixel matrix 216 configured based on the scanned in pixel data for the current composite frame, the steered backlight is transmitted through, and modified by, the selectively-transmissive display pixel matrix 216, resulting in display light that contains the visual content represented by the composite frame. This steered display light in turn is separated by the lenticular array 220 in to a left-eye image and right-eye image, with the display light corresponding to the left-eye image refracted in a direction corresponding to a left-eye exit pupil that coincides with the expected position of the left eye of the viewer selected at viewer display subprocess 804 and with the display light corresponding to the right-eye image refracted in a direction corresponding to a right-eye pupil that coincides with the expected position of the right eye of the selected viewer.

Thus, in one iteration of the viewer display subprocess 804 for a corresponding frame period, a 3D image is generated and displayed in the expected direction of a selected viewer. For the next frame period, a next iteration of the viewer display subprocess 804 is performed for the next selected viewer, resulting in generation of a 3D image and display of that 3D image in the direction of the next selected viewer, and so forth. In this manner, 3D images can be generated and steered to different viewers in an interleaved pattern, resulting in multiple interleaved video streams being presented to multiple viewers concurrently. For example, if the display system 100 has a refresh rate of 220 frames per second (fps) and there are two viewers, then each viewer can be presented a separate video stream at an effective rate of 60 fps. Similarly, if there are three viewers, then a separate 3D video stream can be displayed to each viewer at an effective rate of 40 frames per second. Thus, through the use of a parallax barrier-steerable backlight as described herein, multiple viewers each can be presented with a separate 3D video stream at the full resolution of the display panel 202, and with only the frame rate being primarily affected based on the number of viewers being concurrently supported.

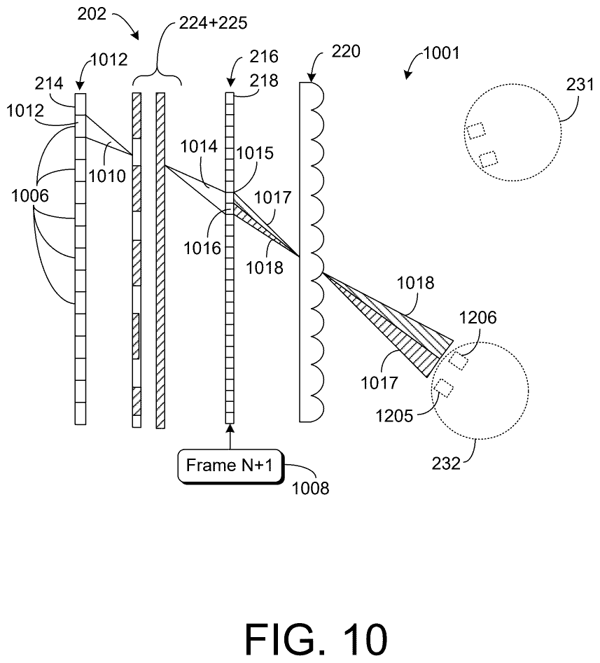

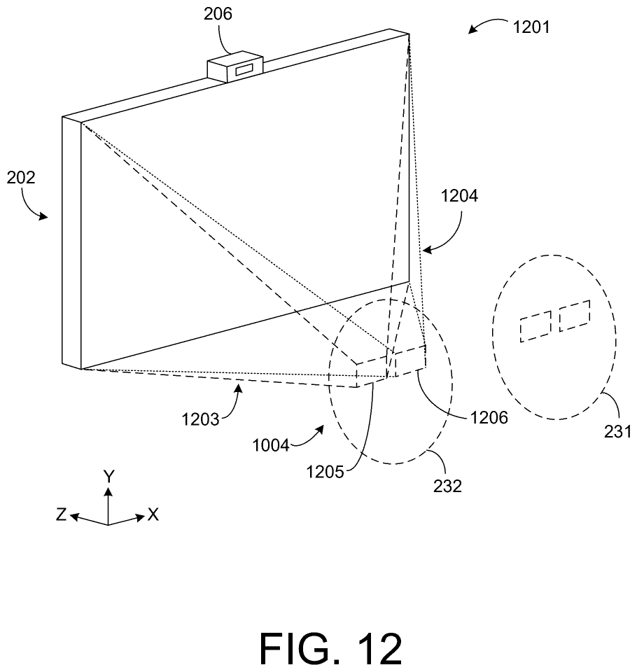

FIGS. 9-12 together illustrate an example operation of the method 800 in the autostereoscopic display system 100 for a two-viewer configuration. FIG. 9 depicts a plan/cross-section view 901 of the display panel 202 and the two viewers 231, 232 for display of a composite frame N to viewer 231, and FIG. 11 depicts a corresponding perspective view 1101 of the display panel 202 and two viewers 231, 232 during display of this composite frame N. FIG. 10 depicts a plan/cross-section view 1001 of the display panel 202 and the two viewers 231, 232 for display of a next composite frame N+1 to viewer 232, and FIG. 12 depicts a corresponding perspective view 1201 of the display panel 202 and two viewers 231, 232 during display of composite frame N+1.

Turning to plan view 901 of FIG. 9 and corresponding perspective view 1101 of FIG. 11, the viewer 231 is detected by the viewer tracking subsystem 206 to have a current pose 904 for the upcoming display of frame N. Accordingly, the viewer steering application 254 provides a representation of the current pose 904 (e.g., a representation of the position of the viewer 231) as input to the LUT 256 and obtains as output an identifier representing a subset 906 (FIG. 9) of backlight pixels 214 that correspond to the current pose 904, where in this simplified example the subset 906 is composed of the indicated columns of backlight pixels 214 that form a first pattern with a corresponding period, phase, and duty-cycle that results in backlight and, consequently, transmissively-modified display light to be propagated in the direction of the current pose 904 of the viewer 231. Concurrently, pixel data 908 (FIG. 9) representative of the composite frame N is scanned into the selectively-transmissive display pixel matrix 216. Responsive to a vertical blank (VBLANK) signal or other timing signal signaling the start of the frame period for frame N, the backlight controller 244 configures the BKLT_CTL signal 252 to activate the backlight pixels 214 of the subset 906 while maintaining the other backlight pixels 214 of the backlight 212 in an inactivated or low-activation state. So activated, the backlight pixels 214 of the subset 906 emit backlighting, which is collimated and steered by the parallax barrier 224 and diffuser 225 through the selectively-transmissive display pixel matrix 216 and the lenticular array 220, resulting in display light representing the visual content of composite frame N that is projected from the display panel 202 in a direction that intersects the current pose 904 and thus presents 3D imagery to the viewer 231. In particular, through the use of a composite frame that contains interleaved left-eye and right-eye images, and through the subsequent separation of the display light for each of these two images by the lenticular array 220, this display light is projected as left-eye display light 1103 (FIG. 11) and right-eye display light 1104 (FIG. 11) toward a left-eye exit pupil 1105 (FIG. 11) and a right-eye exit pupil 1106 (FIG. 11), respectively, that coincide with the expected position of the left eye and right eye, respectively, of the viewer 231 while at pose 904.

View 901 of FIG. 9 further illustrates this process by way of a simple example with reference to the backlight from a single row of backlight pixels 214 and two rows of display pixels 218. Activation of the subset 906 results in backlighting 910 emitted by a column 912 of backlight pixels 214. This backlighting 910 is collimated and steered by the parallax barrier 224 and diffuser 225 in a direction that causes the resulting steered backlighting 914 to transmit through adjacent pixel columns 915, 916 of the display pixel matrix 216, resulting in the conversion of the incident backlighting into display light 917 from pixel column 915 and display light 918 from pixel column 916. In this example, pixel column 915 contains pixel data for a corresponding column of the left-eye image of the composite frame N and pixel column 916 contains pixel data for a corresponding column of the right-eye image of the composite frame N, and thus the display light 917 contains visual content intended for perception by the left eye of the viewer 231 and the display light 918 contains visual content intended for perception by the right eye of the viewer 231. The display light 917, 918 is transmitted though the lenticular array 220, with the lenticular array 220 steering the display light 917 in a direction that forms the left-eye exit pupil 1105 for the left eye of the viewer 231 and steering the display light 918 in a direction that forms the right-eye exit pupil 1106 for the right eye of the viewer 231, and thereby presenting the viewer 231 with a stereoscopic 3D image represented by composite frame N.

Turning now to plan view 1001 of FIG. 10 and corresponding perspective view 1201 of FIG. 12, the viewer 232 is detected by the viewer tracking subsystem 206 to have a current pose 1004 for the upcoming display of frame N+1. Accordingly, the viewer steering application 254 provides a representation of the current pose 1004 as input to the LUT 256 and obtains as output an identifier representing a subset 1006 (FIG. 10) of backlight pixels 214 that correspond to the current pose 1004, where in this simplified example the subset 1006 is composed of the indicated columns of backlight pixels 214 that form a second bar pattern with a corresponding period, phase, and duty-cycle that results in backlight and, consequently, transmissively-modified display light to be propagated in the direction of the current pose 1004 of the viewer 232. Concurrently, pixel data 1008 (FIG. 10) representative of the composite frame N+1 is scanned into the selectively-transmissive display pixel matrix 216. Responsive to a timing signal signaling the start of the frame period for frame N, the backlight controller 244 configures the BKLT_CTL signal 252 to activate the backlight pixels 214 of the subset 1006 while maintaining the other backlight pixels 214 of the backlight 212 in an inactivated or low-activation state. So activated, the backlight pixels 214 of the subset 1006 emit backlighting, which is collimated and steered by the parallax barrier 224 and diffuser 225 through the selectively-transmissive display pixel matrix 216 and the lenticular array 220, resulting in display light representing the visual content of composite frame N+1 that is projected from the display panel 202 in a direction that intersects the current pose 1004 and thus presents 3D imagery to the viewer 232. In particular, through the use of a composite frame and operation of the lenticular array 220, this display light is projected as left-eye display light 1203 (FIG. 12) and right-eye display light 1204 (FIG. 12) toward a left-eye exit pupil 1205 (FIG. 12) and a right-eye exit pupil 1206 (FIG. 12), respectively, that coincide with the expected position of the left eye and right eye, respectively, of the viewer 232 while at pose 1004.

View 1001 of FIG. 10 further illustrates this process by way of a simple example with reference to the backlight from a single row of backlight pixels 214 and two rows of display pixels 218. Activation of the subset 1006 results in backlighting 1010 emitted by a column 1012 of backlight pixels 214. This backlighting 1010 is collimated and steered by the parallax barrier 224 and diffuser 225 in a direction that causes the resulting steered backlighting 1014 to transmit through adjacent pixel columns 1015, 1016 of the display pixel matrix 216, resulting in the conversion of the incident backlighting into display light 1017 from pixel column 1015 and display light 1018 from pixel column 1016. In this example, pixel column 1015 contains pixel data for a corresponding column of the left-eye image of the composite frame N+1 and pixel column 1016 contains pixel data for a corresponding column of the right-eye image of the composite frame N+1, and thus the display light 1017 contains visual content intended for perception by the left eye of the viewer 232 and the display light 1018 contains visual content intended for perception by the right eye of the viewer 232. The display light 1017, 1018 is transmitted though the lenticular array 220, with the lenticular array 220 steering the display light 1017 in a direction that forms the left-eye exit pupil 1205 for the left eye of the viewer 232 and steering the display light 1018 in a direction that forms the right-eye exit pupil 1206 for the right eye of the viewer 232, and thereby presenting the viewer 232 with a stereoscopic 3D image represented by composite frame N+1.

The process illustrated by FIGSs. 9-12 can be iteratively performed by interleaving composite frames intended for viewer 231 with composite frames intended for viewer 232, with viewer 231 being presented with a video stream implemented via the presentation of composite frames N+i (i=0, 2, 4, 6, 8, . . . ) steered to the most recently detected pose of the viewer 231 via the backlight steering process described above, while viewer 232 is presented with a video stream implemented via the presentation of composite frames N+k (k=1, 3, 5, 7, 9, . . . ) steered to the more recently detected pose of the viewer 232 via this same backlight steering process.

In accordance with one aspect, an autostereoscopic display system includes a transmissive display panel comprising a backlight having an array of backlight pixels; a selectively-transmissive display pixel matrix having a first side facing the backlight and an opposing second side, the selectively-transmissive display pixel matrix comprising an array of display pixels; a parallax barrier disposed between the backlight and the first side of the selectively-transmissive display pixel matrix; and a lenticular array disposed facing the second side of the selectively-transmissive display pixel matrix. The backlight is configured to separately activate different subsets of the backlight pixels such that light emitted from an activated subset of backlight pixels and transmitted through the parallax barrier the selectively-transmissive display pixel matrix, and the lenticular array is emitted by the display panel as display light in a corresponding separate direction relative to the display panel.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, such terms must be correspondingly modified.

Although certain example methods, apparatuses and articles of manufacture have been described herein, the scope of coverage of this patent is not limited thereto. It is to be understood that terminology employed herein is for the purpose of describing aspects and is not intended to be limiting. On the contrary, this patent covers all methods, apparatus and articles of manufacture fairly falling within the scope of the claims of this patent.

What is claimed is:

1. A system, comprising:
a backlight that includes an array of backlight pixels, a diffuser, and a parallax barrier located between the array of backlight pixels and the diffuser;
a lenticular array; and
a display pixel matrix that is selectively-transmissive and located between the backlight and the lenticular array;
wherein the backlight is configured to activate a subset of the backlight pixels to provide illumination to form a stereoscopic pair of images directed towards a viewer pose.

2. The system of claim 1, wherein the system directs stereoscopic pairs of images across a viewing cone greater than 70 degrees and within an illumination cone less than 40 degrees.

3. The system of claim 1, wherein the parallax barrier includes elongate apertures oriented in a vertical direction.

4. The system of claim 3, wherein the array of backlight pixels include columns of pixels that are transverse to the elongate apertures.

5. The system of claim 1, wherein the parallax barrier is disposed directly adjacent the array of backlight pixels.

6. The system of claim 1, wherein the diffuser is disposed directly adjacent the parallax barrier.

7. The system of claim 1, wherein the parallax barrier provides a directionality to light emitted by the backlight pixels for directing the stereoscopic pair of images towards the viewer pose.

8. The system of claim 1, wherein the diffuser diffuses elongate brightness non-uniformities emitted by the parallax barrier to provide a more uniform illumination of the display pixel matrix.

9. The system of claim 1, wherein the diffuser is a top hat diffuser.

10. The system of claim 1, further comprising a display controller configured to:
activate a first subset of the backlight pixels for display of a first frame such that light emitted from the first subset of the backlight pixels is steered through the parallax barrier and forms first display light in a first direction; and
activate a second subset of the backlight pixels for display of a second frame such that light emitted from the second subset of the backlight pixels is steered through the parallax barrier and forms second display light in a second direction that is different than the first direction.

11. The system of claim 10, further comprising:
a viewer tracking subsystem configured to track a pose of a corresponding one or more viewers;
wherein the first subset of the backlight pixels is selected based on a pose of a first viewer such that the first direction intersects with the pose of the first viewer; and
wherein the second subset of the backlight pixels is selected based on a pose of a second viewer such that the second direction intersects with the pose of the second viewer.

12. The system of claim 11, wherein:
each of the first frame and the second frame comprises a three-dimensional composite frame comprising a first subset of pixels representing image content for a left eye of a viewer of one or more viewers and a second subset of pixels representing image content for a right eye of the viewer.

13. A method comprising:
activating a first subset of backlight pixels of a backlight of a display panel to transmit light through a parallax barrier adjacent the backlight, a diffuser disposed adjacent the parallax barrier, a display pixel matrix that is selectively-transmissive and disposed adjacent the diffuser, and a lenticular array disposed adjacent the display pixel matrix so that the display panel emits first display light representative of a first frame in a first direction relative to the display panel; and
activating a second subset of backlight pixels of the backlight to transmit light through the parallax barrier, the diffuser, the display pixel matrix, and the lenticular array so that the display panel emits second display light representative of a second frame in a second direction different than the first direction relative to the display panel.

14. The method of claim 13, wherein the first display light forms a first stereoscopic pair of images within a first illumination cone that is less than 40 degrees, the second display light forms a second stereoscopic pair of images within a second illumination cone that is less than 40 degrees, and an angular distance between the first illumination cone and the second illumination cone is greater than 70 degrees.

15. The method of claim 13, further comprising:
determining a first pose of a first viewer and a second pose of a second viewer;
selecting the first subset of backlight pixels based on the first pose of the first viewer; and
selecting the second subset of backlight pixels based on the second pose of the second viewer.

16. The method of claim 15, further comprising:
generating the first frame based on the first pose of the first viewer; and
generating the second frame based on the second pose of the second viewer.

17. The method of claim 16, wherein the first frame and the second frame each comprise a three-dimensional (3D) composite frame including a first subset of pixels representing image content for a left eye of at least one of the first viewer or the second viewer and a second subset of pixels representing image content for a right eye of the at least one of the first viewer or the second viewer.

18. The method of claim 13, wherein:
activating the first subset of backlight pixels produces a first bar pattern of backlighting; and
activating the second subset of backlight pixels produces a second bar pattern of backlighting.
